(19) United States
(12) Patent Application Publication
(10) Pub. No.: US 2005/0108777 A1
(43) Pub. Date: May 19, 2005

(54) Apparatus and a method for inserting text into a display monitor of a self storage facility

(76) Inventors: Anthony Carlis, East Brandywine, PA (US); James Del Sordo, East Brandywine, PA (US)

Correspondence Address: The Law Office of Anthony R. Carlis;Invent This! Inc., 34 Kristin Circle, Downigtown, PA, 19335, US

(21) Appl. No.: 10/991,675

(22) Filed: Nov. 18, 2004

Related U.S. Application Data
(60) Provisional application No. 60/481,661, filed on Nov. 18, 2003.

(51) Int. Cl. H04N 11/00; H04N 7/16; H04N 7/00

(52) U.S. Cl. 725/136; 348/468

(57) ABSTRACT

The present converts the printer output data from a system controller utilized at a self storage facility and displays it on a monitor. The monitor is usually connected to a camera which monitors the self storage facility. In addition, the converted output data can be recorded by a digital video recorder, which records camera video. The printer data can be placed into a searchable data base.

### CROSS REFERENCE TO RELATED APPLICATION

This application claims priority from U.S. provisional application No. 60/481,661 which was filed on Nov. 18, 2003, which is incorporated by reference as if fully set forth.

### BACKGROUND OF THE INVENTION

The Self-storage industry has become an important aspect of everyday life. Self storage facilities proliferate this country's landscape and can be found all over the world. Self storage facilities provide a rentable semi-permanent solution to store all kinds of things. They are user friendly and provide easy twenty-four hour, seven days a week access to the client's stored stuff.

A Self-storage facility comprises a plurality of individual storage units enclosed by a secured perimeter. A typical arrangement has the storage unit with a lockable garage type door attached to a shed-like structure. The self storage unit's garage type door allows for access to the interior of the storage unit and the locking mechanism secures the door member in a locked position. In addition, the door may have an alarm or some type of indicating device which sends notice to a system controller that that door is open or closed.

The secured perimeter typically includes a fence or barrier surrounding the storage facility having at least one gate for ingress and egress. The gate restricts access to only those individual clients who have proper clearance or authorization to enter the storage facility. For example, an electronic gate controller is programmed to only allow access to individual customers who have their rents paid up to date.

Storage units are usually rented for various periods of time to accommodate the needs of the client. The renting of the individual storage unit is typically accomplished by someone physically manning each storage facility with an attendant. This attendant conducts the transactions necessary with potential and current customers. The Patriot Act in conjunction with moststate statutes makes it mandatory to have a person present to check each renter's credentials before renting them a storage unit.

A problem can occur while the attendant is giving a tour of the facility to a potential client. While the attendant is away, no one is at the self storage facility's office to watch the video monitor(s) or alarm(s). If some nefarious activity occurs, no one is present to view it. A second attendant could be added to aide the first attendant, but this increases the overhead costs associated with operating the self storage facility.

Additionally, while the attendant is busy, he or she will not be able to monitor ingress or egress of the storage facility. While a camera and a video recorder can watch and record the self storage facility's activities, there is no way to link activity to the video recorder. For example, when someone at an entrance keypad enters an invalid access code to open a front gate, the attendant may be away. There is no accurate way to determine what happened at the keypad from the recorded video even though an event log was generated by a system controller. This is because the recorded video is not linked to the storage facility's system controller. The system controller is a free standing microprocessor based system which monitors and operates the gates and the open-closed alarms on the individual storage units. System controllers in use only have a parallel portto print out an activity log to a dot matrix printer and there is no physical link between the system controller and the video monitoring system.

Therefore a need exists to display system controller activity onto a display monitor. There is even a greater need to collect the system controller's event log data to a database and allow searching by time, by event, by camera or by a change in display. A change in display occurs when a video system detects any change in an image and tells the video recorder to start recording.

### SUMMARY

The present invention translates event report data from a self storage facility's system controller and displays it on a video monitor. The video monitor is usually connected to at least one camera which monitors the self storage facility. In addition, the translated event report data can be stored in a searchable database for later look-ups and cross-referencing. The invention will be further able to filter the system controller's event report by fields and route appropriate data to an appropriate video overlay which corresponds to an area where the event occurred, thereby providing necessary correlation between the recorded video and the occurring events.

### BRIEF DESCRIPTION OF THE DRAWING(S)

FIG. 1 shows a block diagram of one aspect of the present invention.

FIG. 2 shows a block diagram shows a second aspect of the present invention

### DETAILED DESCRIPTION

The present invention will be described with reference to the drawing figures wherein like numerals represent like elements throughout.

The present invention can be first utilized in a self storage environment where a system controller has a printer output or any output which produces a log of system controller's events. The system controller can have a printer port, a serial port, an USB port, a fire wire or any other type of communications link.

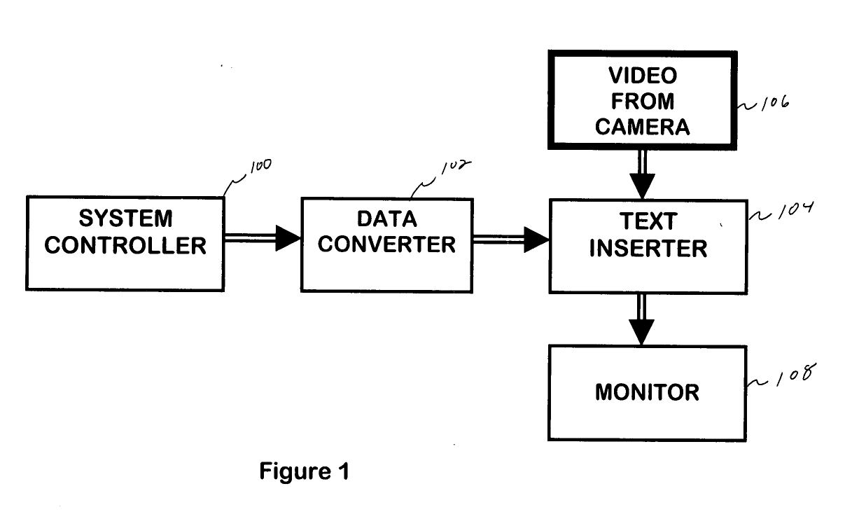

The event data may be first converted to another format which is more amenable to travel over distances. Referring to FIG. 1, the event data comes from the system controller 100 and is applied to a data converter 102. The data converter 102 applies the converted data to the text inserter 104 which overlays text from a monitoring camera 106 and displays it on a monitor 108. The output of the text inserter may also be applied to a video recorder for later play back, this first aspect of the present invention does not include event searches.

For example, a customer enters a wrong entrance code into the front gate controller keypad. The denied access information which is produced by the system controller 100 indicates that an erroneous access code was entered by a customer. The keypad and its location, along with a time stamp are sent by the system controller 100 to an output port as event data. The event data is converted to overlay text video by text inserter 104 and displayed on a monitor 108.

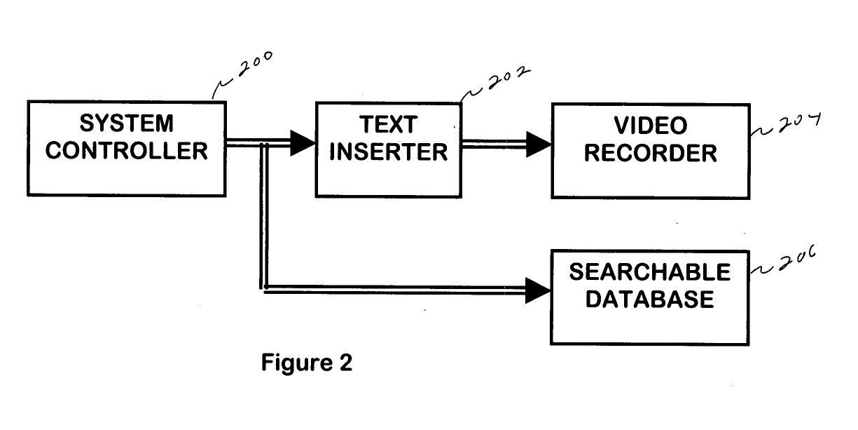

Referring to FIG. 2, another embodiment has the event data from a second system controller 200 sent to a text inserter 202. The output of the text inserter is applied to the video recorder 204. The event data is also sent to a searchable database 206. The video recorder 204 and the searchable database 206 may or may not be the same computer. This combination of searchable database 206 and video recorder 204 allows events to be searchable by time, event type, customer or any database field.

For example, a customer enters a wrong entrance code into the front gate controller keypad. The denied access information which is produced by the system controller 200 indicates that an erroneous access code was entered by a customer. The keypad and its location, along with a time stamp are sent by the system controller 200 to an output port of the system controller 200 as event data. The event data is converted by text inserter 202 and the camera video is overlaid with text information from the system controller 200 and displayed on a monitor and or stored in a video recorder 204. In addition, the event data is sent and stored to a searchable database 206. The information is then searchable by field or combination of fields. The attendant will be able to request a video image along the time and trouble code. This information is extremely important when a crime was committed at the self storage facility and one or more law enforcement agencies are on the scene needing information.

In yet another embodiment, the video and event data may be stored on different computers. A first computer has the event data database and the second has the digital video recorder. Through the use of database transactional calls from a program on the digital video recorder to the database computer the two computers will act seamlessly to the end user as the requested information is displayed on the computer which is running a monitoring program.

In still yet another embodiment, three or more computers may be used to store the searchable database, the digital video and to run a computer program which executes instructions to request the event data and video data for certain date and time stamps.

In still yet another embodiment, the event data from the system controller is applied directly to the computer with the video recorder. This allows the more efficient use of resources. The computer will internally overlay the video text by making appropriate calls to the video card through the computers operating system. It may necessary with some system controllers to convert its parallel output to a computer friendlier format such as serial or USB.

In another embodiment, the system controller may be incorporated into the computer, such as an IBM PC running windows, dos, unix or Linux. The computer may also be of the Apple variety. This can be accomplished through the use of video multiplexing (mux) cards and the computers input and output (i/o). The computer can even be linked via USB for example, to a system controller type box to isolate the physical wiring away from the computer.

1. A video text inserter for use in a self storage environment comprising;
a system controller with a communications port,
a data conversion entity for converting data from said communications port to video text; and
means for displaying said video text on a video display.

2. The invention of claim 1 further comprising;
means for overlaying said video text the video display with a video signal from a first camera.

3. The invention of claim 2 further comprising;
means for storing said system controller's data in a searchable database.

4. The invention of claim 3 further comprising;
means for decoding the system controller's data; and
means for selecting from at least one of a plurality of video cameras and overlaying video text on at least one of a plurality video outputs based upon a data field in the system controller's data.

5. A method to use a video text inserter for use in a self storage environment;
linking a system controller with a communications port,
converting data from said communications port to video text; and
displaying said video text on a video display.

6. The method of claim 5 further comprising;
overlaying said video text the video display with a video signal from a first camera.

7. The method of claim 6 further comprising;
storing said system controller's data in a searchable database.

8. The method of claim 7 further comprising;
decoding the system controller's data;
selecting from at least one of a plurality of video cameras; and
overlaying video text on at least one of a plurality video outputs based upon a data field in the system controller's data.

9. The invention of claim 4:
wherein a computer has incorporated into itself an internal system controller for operating and monitoring the self storage facilities doors and alarms;
said computer also has the searchable database;
said computer overlays and switches video based upon database fields; and
said computer stores the video data in a digital format.

10. The invention of claim 9:
wherein said computer may be one or more of a plurality of computers sharing the tasks of video and text capture and storage amongst themselves.

11. The method of claim 8 further comprising:
operating a computer which has incorporated into itself an internal system controller,
operating and monitoring the self storage facilities doors and alarms via said computer;
providing the searchable database on said computer;
overlaying and switching the video and/or text on said computer based upon database fields; and
storing the video data in a digital format on said computer.

12. The method of claim 11 wherein the system may be on one or more of a plurality of computers sharing the tasks of video and text capture and storage amongst themselves.
